(19) United States
(12) Patent Application Publication
(10) Pub. No.: US 2015/0239662 A1
(43) Pub. Date: Aug. 27, 2015

(54) Biodegradable or recyclable small and jumbo trash can liners

(71) Applicant: Doris Jean NOBLE, (US)

(72) Inventor: Doris Jean Noble, Jonesboro, AR (US)

(21) Appl. No.: 14/422,713

(22) PCT Filed: Oct. 4, 2013
(86) PCT No.: PCT/US13/63486

§ 371 Date: Feb. 20, 2015

Related U.S. Application Data
(60) Provisional application No. 61/714,771, filed on Oct. 17, 2012.

(51) Int. Cl. B65F 1/00

(52) U.S. Cl. CPC B65F 1/0006; B65F 2250/105

(57) ABSTRACT

A Trash Cans Liner that cannot be seen on the outside of the Trash Can. It is reusable allowing liquids and not soiling the inside of the Can. The sticky glue at the top portion of the Can holds the liner in place until it is ready to be discarded if necessary. These liners would come in a variety of sizes and colors to fit trash cans of varieties and colors and are completely biodegradable or recyclable.

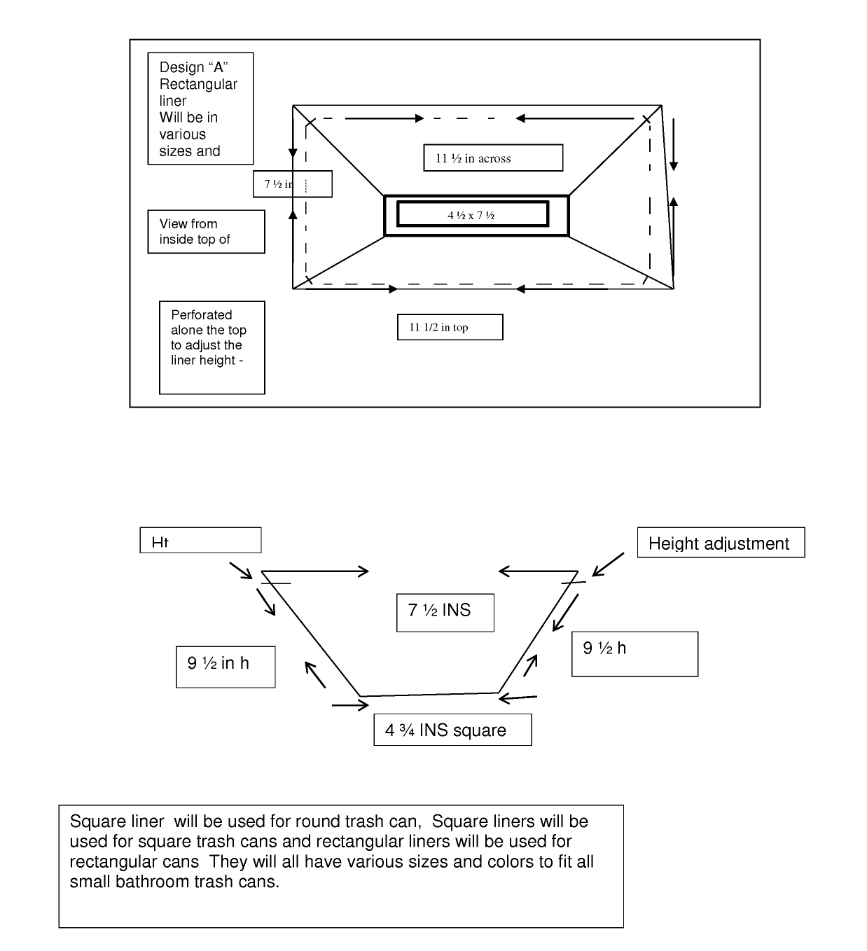

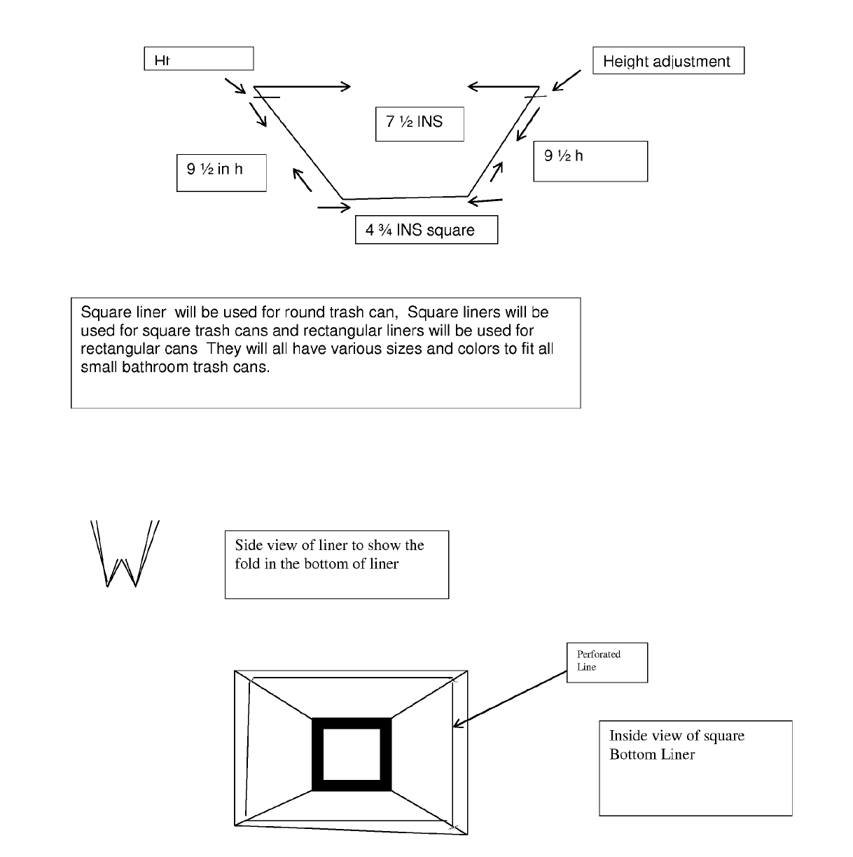

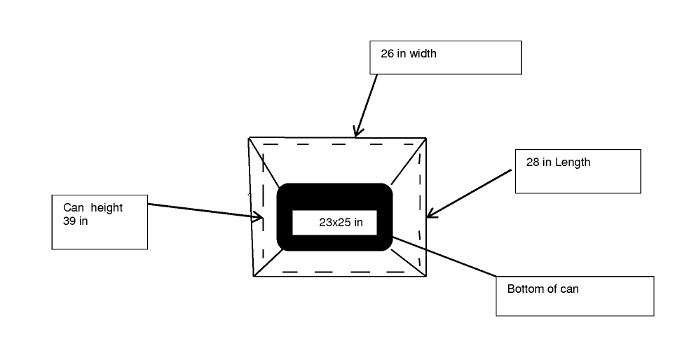

### CROSS REFERENCE

A Provisional patent was filed for this invention on Oct. 17, 2012, given application No. 61714771 with the USPTO as an electronic filing.

### BACKGROUND OF INVENTION

The object of this invention is to help solve a number of problems. One is the improving of our environment with regards to saving our landfills by using noncommercial compostable refuse container such as Trash Can Liners. The second problem is that most individuals are unhappy with their trash can liners for one reason or the other.

### BRIEF SUMMARY

This invention product relates to a protective covering for the inside of small and jumbo trash cans. There are many Trash Can Liners and garbage bags on the market that are biodegradable and recyclable; however most of them do not fit the Trash Can size.

To overcome this problem this liner when placed inside the Trash Can, cannot be seen on the outside of the can thereby not hiding the beauty of the Can. They also fit snugly inside the Can, not allowing waste to have contact with the inside of the Can.

The purpose of these trash can liners is to protect the inside of the trash can and

Ultimately preserve the beauty of the can.

### BRIEF DESCRIPTION OF THE SEVERAL VIEWS OF THE DRAWING

Design A, page one is a rectangular bottom liner with specifications matching the size of the Trash Can that it will fit. The dotted lines show the perforated edge for height adjustment if necessary. The top drawing is the inside view and the bottom drawing is the side view.

Design B page 2 is a square bottom liner with specifications matching the size of the Trash Can that it should fit. In this drawing the top drawing is a side view and the bottom is the inside view. The drawing just up to the left of the inside view shows the fold in the bottom. The fold in the side is exactly the same as the fold in a paper bag.

Design C page 3 is the exact same style as the rectangular liner, only it is on a larger scale.

Jumbo Outdoors Trash Can liner: These Trash Can Liners would fit the Outdoor Trash Cans that are picked up by the Refuse Collectors. I received a new can from the Refuse Company because I had been away for a while and when I opened the can to put my trash in it, it was new and clean. I immediately said, “I wish I had a liner for it”, so I begin to think would it be possible to make a clear (green) liner made with Biodegradable plastics for a Can of this size.

I came to the conclusion that they would be made the same way as the other liners just larger and in clear green material only (Biodegradable plastic). They can actually be folded the very same way as the small Trash Can Liners.

They can also be transported in stacks without the fold. These would have sticky tape completely (of course the sticky would be covered with a layer of seal that would simply peel off to protect it until time for use) surround the inside top of the Can, so that when the cans are dumped, the liner would not automatic come out. In addition, this would not allow any refuse to reenter the Cans. You would first put the liner in the Can then pull the sealer away from the sticky area and just press it against the inside top edge of the Can.

When the owner decides that the liner is ready to be discarded they would simply pull the sticky away from around the inside top of the Can, seal it to itself and allow it to be discarded alone with the trash at the next refuse pickup.

These like the small Trash Can Liners would come in varying sizes and shapes but only in Biodegradable Plastics.

### DETAILED DESCRIPTION OF THE INVENTION

The liners will be various sizes to accommodate most small trash cans, and should fit snugly at the top of most Cans. All liners will have the shape of an upside down trapezoid, with a square or rectangular bottom leaving extra space in the bottom of the Can making it easy to lift the liners from the Trash Cans. This featured design also makes it possible to fit many other Trash Can Sizes. Most liners will not be wider than 12 inches at the top since most small trash cans are not wider than that and many are somewhat oval shaped. The only fold will be the collapse or fold in the side and bottom of the liner, as shown in the design models.

The liners are going to be made of biodegradable materials such as pulp fiber, paperboard, construction paper, non-woven material, washable shelf paper and some will be made of Biodegradable plastics that are compostable in a regular landfill in a reasonable amount of time.

The Liners can be made in one piece or two pieces joined together for easy folding or collapse on the side and at the bottom. The purpose of the folding is for easy packaging.

These Liners will also be made with a small strip of sticky on the outside to stick to the inside of the Trash Can just below the Perforation line for height adjustment. This small piece of tape may or may not be necessary, but it is to hold the liner close to the trash can so that nothing seeps or slips in between the Can and the Liner. All the liners will prevent liquid soiling to the Trash Can for a limited time. If no soiling has occurred then the liner can be used more than once. I have used the same liner in my bathroom trash can for more than a month.

There will be a perforated section at the top of every liner to make height adjustments. The colors of the liners will be in the colors provided from Milk paints, which are biodegradable, non-toxic, and odor-free when dry. We now have access to a large variety of colors even in the biodegradable plastics. These Trash Can Liners are designed to enhance the decor in any room. The (recyclable) washable liners made of shelf paper material will be made in the same shapes and sizes as all the rest. The unique shape is advantage this Liner has over all the rest. Nonwoven materials such as you would see in reusable bags are washable as well as biodegradable. However, most of these need to be taken to a commercial Landfill for decomposing. By the time product goes to market we might have a non-woven that is compostable within 6-9 months.

1. (canceled)

2. (canceled)

3. (canceled)

4. (canceled)

5. (canceled)

6. (canceled)

7. (canceled)

8. A trash can liner that is in the shape and size of the individual trash can; a trash can that you would see in your bedroom, bathroom, or home office that are normally not taller than 15 inches; having: four sides and a bottom; designed to protect the inside of the trash can from puncture, messy substances, liquids, or simply as decoration to the trash can.

9. The trash can liner as claimed in claim 8 further comprises the shape of an upside down trapezoid; sits on its own bottom and is self supporting.

10. The trash can finer as claimed in claim 9 further comprises a close fit to the trash can where top circumference of said liner stops just under the top circumference of the trash can.

11. The trash can liner as claimed in claim 10 further comprises extra space in the bottom of the trash can between the trash canard said liner because of the upside down trapezoid shape which allows for easy removal of said liner from the trash can when emptying.

12. The trash can liner as claimed in claim 11 further comprises at least one perforation line, one inch from top liner circumferences for height and width adjustments to fit multi trash can heights and sites whether trash cans are round, square or rectangular.

13. The trash can liner as claimed in claim 12 further comes in biodegradable non-woven fabric material that is machine washable and in many colors.

14. The trash can liner as claimed in claim 13 further comprises the capability to accept labeling; such as that of an individual company, organization or family name on the inside of said liner.

15. The trash can liner as claimed in claim 14 further comprises materials such as Biodegradable plastics of many colors including clear.

16. The trash can liner as claimed in claim 15 further comprises biodegradable paper materials as paperboard, construction paper and other paper material.

17. A Jumbo trash can liner large enough to fit the inside of an outside trash can that is taken every week by a Refuse Company; has four sides and a bottom, sits on its own bottom and is self-supporting.

18. The jumbo trash finer as claimed in claim 17 further comprises the shape of the trash can itself.

19. The jumbo trash can liner as claimed in claim 18 further comprises an adhesive tape that surrounds the top outside of the liner and connects to the inside of the trash can just under the top circumference and used to keep said liner in place when dumping by the refuse company; said liner can be used for more than one week if the soiling has not punctured the liner; if punctured, removal of the adhesive tape from around the top circumference of trash can, being taped to itself said liner and garbage within said liner will be dumped together by the Refuse company.

20. The jumbo trash can liner as claimed in claim 19 further come in biodegradable plastics only.

21. The jumbo trash can finer as claimed in claim 20 have one perforation line, one inch from the top circumference of said liner used for height and width adjustment, To accommodate multi trash can sizes.
